(19) United States
(12) Patent Application Publication
(10) Pub. No.: US 2009/0298670 A1
(43) Pub. Date: Dec. 3, 2009

(54) METHOD FOR REMOVING GRAPHITE FROM CORDIERITE BODIES

(76) Inventors: Martin Joseph Murtagh, Trumansburg, NY (US); Mark Allen Spetseris, Pine City, NY (US); Doug Wing, Painted Post, NY (US)

Correspondence Address: CORNING INCORPORATED, SP-TI-3-1, CORNING, NY, 14831, US

(21) Appl. No.: 12/163,117

(22) Filed: Jun. 27, 2008

Related U.S. Application Data
(60) Provisional application No. 61/128,964, filed on May 27, 2008.

(51) Int. Cl. C04B 38/00

(52) U.S. Cl. 501/80

(57) ABSTRACT

A method of removing graphite from a core region of a cordierite-forming green body and a method of firing a cordierite-forming green body to form a fired cordierite body. A dried cordierite-forming green body containing graphite is first heated so that the core region is at a first temperature in a range from about 950° C. up to about 1100° C. The green body is then either held at the first temperature or heated to a second temperature in a range from about 1050° C. up to about 1160° C.; in either case resulting in removal of a majority of graphite from the core region. The green body may then be heated to a third temperature in a range from about 1300° C. up to about 1350° C. at a second predetermined heating rate to remove any residual graphite from the core region and then heated to a temperature of at least 1390° C. to form the fired cordierite body.

### CROSS-REFERENCE TO RELATED APPLICATIONS

This application claims the benefit of priority under 35 U.S.C. § 119(e) of U.S. Provisional Application Ser. No. 61/128,964 filed on May 27, 2008.

### BACKGROUND

The invention relates to ceramic materials that contain graphite as a pore former. More particularly, the invention relates to methods of removing graphite from ceramic materials.

Graphite and other pore formers are frequently used in ceramic articles or wares as a pore former within the articles. One example of such articles is cordierite-based honeycomb structures.

The firing of such honeycomb structures containing graphite often results in variations of physical properties between the skin or surface region and the core region of the article, as graphite tends to remain in the core region of the ware. If graphite remains within the core region at temperatures of about 1320° C., the physical properties in the core region of the ware may differ significantly from those at the skin region of the ware. Under such conditions, the core region of the article will have a higher coefficient of thermal expansion (CTE), percentage of porosity, and median pore size compared to the skin region. In addition, the core region will have a higher modulus of rupture (MOR) and elastic modulus (E-mod) than the skin region.

Variability of CTE, MOR, and elastic modulus between the core region and the skin region of the article may decrease the durability of the fired ceramic article. The variability in these physical properties may be so acute as to render the article unsuitable for its intended use.

### SUMMARY

The present invention provides a method of removing graphite from a core region of a cordierite-forming green body and a method of firing a cordierite-forming green body to form a fired cordierite body. A dried cordierite-forming green body containing graphite is first heated so that the core region is at a first temperature in a range from about 950° C. up to about 1100° C. The green body is then either held at the first temperature or heated to a second temperature in a range from about 1050° C. up to about 1160° C.; in either case resulting in removal of a majority of graphite from the core region. The green body is heated to a third temperature in a range from about 1300° C. up to about 1350° C. at a second predetermined heating rate to remove any residual graphite and then heated to a temperature of at least 1390° C. to form the fired cordierite body.

Accordingly, one aspect of the invention is to provide a method of removing graphite from a cordierite-forming green body. The method comprises the steps of: providing the cordierite-forming green body, the cordierite-forming green body having a core region and a skin region and comprising graphite; heating the core region to a first temperature, the first temperature being in a range from about 950° C. up to about 1100° C.; and either: i) holding the core region at the first temperature for a first time interval; or ii) heating the core region from the first temperature to a second temperature at a first predetermined heating rate, the second temperature being greater than the first temperature and in a range from about 1050° C. up to about 1160° C.; and heating the core region from one of the first temperature and the second temperature to a third temperature in a range from about 1300° C. up to about 1350° C. at a second predetermined heating rate, wherein the third temperature is sufficient to remove graphite from the core region of the cordierite-forming green body.

A second aspect of the invention is to provide a method of firing a cordierite-forming green body to form a fired cordierite body. The method comprises the steps of: providing the cordierite-forming green body, the ceramic body having a core region and a skin region; heating the core region to a first temperature, the first temperature being in a range from about 950° C. up to about 1100° C.; either: i) holding the core region at the first temperature for a first time interval; or ii) heating the core region from the first temperature to a second temperature at a first predetermined heating rate, the second temperature being greater than the first temperature and in a range from about 1050° C. up to about 1160° C.; heating the core region from one of the first temperature and the second temperature to a third temperature in a range from about 1300° C. up to about 1350° C. at a second predetermined heating rate, wherein the third temperature is sufficient to remove graphite from the core region of the cordierite-forming green body; heating the core region from the third temperature to a fourth temperature, wherein the fourth temperature is at least 1390° C.; and holding the core region at the fourth temperature for a time interval ranging from about 6 hours up to 20 hours to form the fired cordierite body.

A third aspect of the invention is to provide a cordierite body. The cordierite body has a skin region and a core region and is substantially free of graphite. The core region has a percentage of crystal orientation that is within 3% of that of the skin region.

These and other aspects, advantages, and salient features of the present invention will become apparent from the following detailed description, the accompanying drawings, and the appended claims.

### BRIEF DESCRIPTION OF THE DRAWINGS

FIG. 1 is a schematic perspective view of a body, showing the relationship between skin region and core region; and

FIG. 2 is a plot of temperature the core region of cordierite-forming green bodies as a function of time.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range.

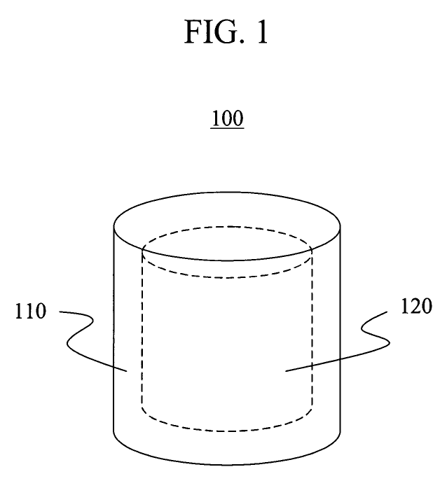

Referring to the drawings in general and to FIG. 1 in particular, it will be understood that the illustrations are for the purpose of describing a particular embodiment of the invention and are not intended to limit the invention thereto. The drawings are not necessarily to scale, and certain features and certain views of the drawings may be shown exaggerated in scale or in schematic in the interest of clarity and conciseness.

As used herein, “firing,” unless otherwise specified, refers to thermal processing at an elevated temperature to form a ceramic material or a ceramic body.

As used herein, “green body” refers to an unsintered extrudate before firing, unless otherwise specified. The green body may contain a vehicle, such as water, or may be dried (i.e., water has been removed). The green body typically comprises at least precursor of a ceramic material. In addition, the green body may also include other materials such as binders, pore formers, and the like.

As used herein, “skin region,” unless otherwise specified, refers to a region of a fired ceramic body or a green body extending 1.5 inch (about 38 mm) inward from the outer surface of the fired ceramic body or green body, and “core region,” unless otherwise specified, refers to the remaining inner portion of a fired ceramic body or a green body. FIG. 1 is a schematic perspective of a body 100, showing the relationship between skin region 110 and core region 120. Body 100 may represent either a cordierite-forming green body or a fired cordierite body.

It is understood that when the core region of a body is being described as being heated to a given temperature, the entire body is heated to achieve that temperature in the core region. For example, a cordierite-forming green body is placed in a heating or firing chamber, such as a furnace or kiln and heated. The temperature inside the chamber is sufficient to heat the core region to a specified temperature.

A method of removing graphite from a cordierite-forming green body is provided. In the first step of the method, a cordierite-forming green body is provided. Raw materials are selected to form a composition of magnesium oxide (MgO), alumina (Al₂O₃), and silica (SiO₂) that will form cordierite on firing. The composition preferably consists essentially of nominally, from about 12 to about 16 wt % MgO, about 33 to about 38 wt % Al₂O₃, and about 49 to about 54 wt % SiO₂. The most preferred composition consists essentially of nominally about 12.5 to about 15.5 wt % MgO, about 33.5 to about 37.5 wt % Al₂O₃, and about 49.5 to about 53.5 wt % SiO₂. Cordierite-forming and cordierite bodies also typically include impurities such as CaO, K₂O, Na₂O, Fe₂O₃, and the like.

Graphite is also included in the batching (i.e., mixing of raw materials) as a pore former or “burnout agent” to provide control of the porosity of the fired cordierite body. Other pore formers, such as cellulose, flour, starches, or the like, may be added in addition to graphite. Pore formers typically burn out during firing of the green cordierite body. Graphite comprises from about 1 wt % up to about 60 wt % and, in one embodiment, 3 wt % up to about 40 wt %, of the batched raw materials.

The raw materials and graphite are then blended with a vehicle and forming aids, which impart plastic formability and green strength to the raw materials. All of the components are mixed together in dry form and then mixed with the vehicle (typically water) to form a plastic mixture. The plastic mixture is then formed into a green body. In one embodiment, the green body is formed by extrusion. Extrusion techniques, such as ram or screw extrusion, are well known in the art.

The green body may be shaped into any desired shape or size, depending on the application. In one embodiment, the green body is a honeycomb structure. Some examples of honeycomb structures include, but are not limited to, those having cell densities (i.e., cells per unit area) ranging from about 94 cells/cm² (about 600 cells/in²) to about 15 cells/cm² (about 100 cells/in²). Honeycombs having cell densities ranging from about 15 cells/cm² up to about 30 cells/cm², (about 100 to about 200 cells/in²) and wall thicknesses ranging from about 0.30 mm up to about 0.64 mm (about 12 mil to about 25 mil) are especially suited for diesel particulate filter applications.

Once the green body is formed, it is dried at a temperature sufficient to remove any water or liquid phases that might be present. The dried cordierite-forming green body is ultimately fired to form a cordierite body. In the method described herein, the dried cordierite-forming green body is heated before firing to remove graphite from both the skin region and the core region of the green body before firing temperatures are reached. Graphite is more readily removed from the skin region than from the core region of the green body.

Graphite burnout initiates at about 600° C. The reaction mechanism for graphite burnout favors production of carbon monoxide (CO) at temperatures below about 900° C., whereas carbon dioxide (CO₂) production is favored at higher temperatures. Heating schedules for graphite removal and firing of cordierite bodies currently include shorter ramp times up to the final firing temperature, which is typically greater than about 1320° C. Consequently, graphite is retained in the core region of the body and is burned out of the cordierite body at higher temperatures. When graphite remains in the core region at higher temperatures, the physical properties of the core region will differ significantly from those of the remainder of the body. The core region, for example, will have a higher coefficient of thermal expansion (CTE), percentage porosity (also referred to as “intrusion”), and median pore size than the skin region of the fired cordierite body due to the presence of graphite. In addition, the core region will have a lower modulus of rupture (MOR) and elastic modulus (E-mod) than the skin region. The variability in CTE, MOR, and E-mod may result in a less durable product or a product that is unsuitable for its intended use. In some embodiments, however. graphite remaining in the core region at temperatures up to about 1250° C. to about 1300° C. can create differences in properties such as lower core CTE, lower core E-mod, or the like, that are advantageous.

The cordierite-forming green body, having been dried, is first heated so that the core region is heated to a temperature (also referred to herein as the “first temperature”) in a range from about 950° C. up to about 1100° C. in an atmosphere having an oxygen concentration ranging from about 8% up to about 18%. In one embodiment, the core region is held at the first temperature for a first time interval, wherein the first time interval is sufficient to remove a majority of the graphite from the core region. After heating at the first temperature, a residual amount (less than about 10 wt %) of the initial amount of graphite may remain in the cordierite-forming green body.

In another embodiment, the cordierite-forming green body is heated so that the core region is heated at a first predetermined heating rate from the first temperature to a second temperature in an atmosphere having an oxygen concentration ranging from about 9% up to about 13%. In one embodiment, the green body is heated in an atmosphere comprising from about 11% up to about 12% oxygen. The first predetermined heating rate, in one embodiment, is less than or equal to about 10° C./hr, whereas in another embodiment, the first predetermined heating rate is less than or equal to about 3° C./hr. The second temperature is greater than the first temperature and is in a range from about 1050° C. up to about 1160° C., and may be sufficient to remove the graphite from the core region. In one particular embodiment that has been found to be particularly advantageous for green bodies having a volume of up to 2598 in³ (about 42,600 cm³), the cordierite-forming green body is heated from a first temperature of about 1000° C. up to about 1160° C. at a rate of less than about 4° C./hr. In one embodiment, the core region is held at the second temperature for a second time interval. The second time interval is sufficient to remove a majority of the graphite from the core region of the cordierite-forming green body. After heating at the second temperature, a residual amount (less than about 10 wt %) of the initial amount graphite may remain in the cordierite-forming green body.

Following removal of a majority of the graphite from the cordierite-forming green body by either holding the cordierite-forming green body at the first temperature or heating the cordierite-forming green body to the second temperature, the cordierite-forming green body is then heated so that the core region of the body is heated to a third temperature at a predetermined heating rate (second heating rate) to remove any residual graphite from the core region. The third temperature is in a range from about 1300° C. up to about 1350° C. in one embodiment, the second heating rate is in a range from about 5° C./hr up to about 100° C./hr. In one embodiment, the third temperature is about 1320° C.

A method of firing a cordierite-forming green body to form a cordierite body is also provided. A dried cordierite-forming green body is first provided and graphite is removed from the cordierite-forming green body by either: i) heating the cordierite-forming body so that the core region of the body is heated to a first temperature under an atmosphere having an oxygen concentration ranging from about 9% up to about 13%, and in one embodiment, from about 11% up to about 12% oxygen, and held at the first temperature for a first time that is sufficient to remove a majority of the graphite from the core region; or ii) heating the cordierite-forming green body so that the core region is heated at a first predetermined heating rate from the first temperature to a second temperature under an atmosphere having an oxygen concentration ranging from about 9% up to about 13%, and in one embodiment, from about 11% up to about 12% oxygen, as described hereinabove. The cordierite-forming green body is then heated to a third temperature at a predetermined heating rate (second heating rate) to remove any residual graphite from the core region. The third temperature is in a range from about 1300° C. up to about 1350° C. In one embodiment, the third temperature is about 1320° C. in a preferred embodiment, graphite is completely removed from the core region when the temperature of the core region reaches 1320° C. The second heating rate is in a range from about 5° C./hr up to about 100° C./hr.

The body is heated so that the core region of the body is heated from the third temperature to a fourth temperature of at least 1390° C. The fourth temperature is less than the melting point of cordierite (about 1450° C.). The core region is held at the fourth temperature for a time period ranging from about 6 to about 20 hours to fire the body and thus form the cordierite body by converting the cordierite-forming materials in the body to cordierite. The fired cordierite body typically comprises at least 90% cordierite by weight. The actual length of the time period depends upon the size of the body. Firing of the green body at temperatures above about 1390° C. is typically carried out in air in either a periodic or tunnel kiln.

The methods described herein result in fired cordierite bodies that are substantially free of graphite and having uniform physical properties throughout the body; i.e., variation of different physical properties such as, but not limited to, CTE, MOR, porosity, E-mod, crystal orientation, and the like between the core region and skin region are minimized. In one embodiment, the core region of the fired cordierite body has a total intrusion (i.e., porosity or volume of open pores, expressed in cm³/g) that is within 10% and, in other embodiments, within 5% of that of the skin region. Similarly, the core region of the fired cordierite body, in another embodiment, has a mean pore size that is within 10% and, in other embodiments, within 5% of that of the skin region. In another embodiment, the core region of the fired cordierite body has a modulus of rupture that is within 10% and, in other embodiments, within 5% of that of the skin region of the body. In a fourth embodiment, the core region of the fired cordierite body has an elastic modulus that is within 10% and, in other embodiments, within 5% of that of the skin region. Variability in the degree of crystal orientation or texture in the core and skin regions is also reduced by the methods described herein. In one embodiment, the core region of the fired cordierite body has a percentage of crystal orientation that is within 3% of that of the skin region.

A cordierite body having a core region that is substantially free of graphite is also provided. Graphite is removed from the core region of the cordierite body and the body is fired using the graphite removal and firing methods described herein. The percentage or degree of crystal orientation in the core region is within 3% of that of the skin region. In one embodiment, the core region of the cordierite body has a total intrusion (i.e., porosity or volume of open pores, expressed in cm³/g) that is within 10% of that of the skin region. Similarly, the core region of the cordierite body, in another embodiment, has a mean pore size that is within 10% of that of the skin region. In another embodiment, the core region of the cordierite body has a modulus of rupture that is within 10% of that of the skin region of the body. In a fourth embodiment, the core region of the cordierite body has an elastic modulus that is within 10% of that of the skin region.

### EXAMPLE

The following example illustrates the features and advantages of the invention, and is no way intended to limit the invention thereto.

Dried cordierite-forming green honeycomb bodies (2598 in³ (about 42,600 cm³) volume, 200 cells/in² (about 31 pores/cm²) cell density, wall thickness 12 mil (about 0.305 mm) were heated such that the core region of each sample was heated to a first temperature of 1000° C. and then to a second temperature of 1600° C. at a heating rate ranging from 3.31° C./hr (Sample 3) up to 3.86° C./hr (Sample 1) under an atmosphere having an average oxygen concentration ranging from 9.3% (Sample 1) up to 11.4% (Sample 3). Each green honeycomb body comprised about 17% graphite by weight. The results of measurements of CTE, mean pore size (MPS), total intrusion volume (Tot. Int. Vol.), MOR, E-mod, and transverse I-ratio for samples take from skin and core regions of the fired cordierite bodies obtained from these samples are listed in Table 1.

CTE measurements reported in Table 1 were carried out from room temperature up to 800° C. MOR and total intrusion volume were measured at room temperature using mercury porosimetry.

The transverse I-ratio is derived from the intensity ratio (IR or I-ratio), and is a measure of the extent to which the crystallographic c-axes of the cordierite crystals in the fired cordierite body are preferentially oriented parallel to the surface of the walls of the body. The transverse I-ratio is used to describe the degree of preferred orientation.

The transverse I-ratio is measured by the impingement of x-rays on the as-formed wall surfaces of the fired cordierite body. in those instances where the fired cordierite body has a honeycomb structure, measurement of the transverse I-ratio is performed by slicing the cordierite honeycomb substrate to expose a flat section of a wall of the honeycomb and subjecting this wall surface to x-ray diffraction and calculating the intensities of the observed diffraction peaks. If the obtained I-ratio value is greater than 0.65, which is the I-ratio for a body of completely randomly oriented crystals (i.e., a powder), then it can be inferred that the cordierite crystallites have a preferred orientation; i.e., a majority of the cordierite crystallites are oriented with their c-axes in the plane of the wall. A transverse I-ratio of 1.00 would imply that all of the cordierite crystallites are oriented with their negative expansion axis within the plane of the wall. Thus, the closer the transverse I-ratio is to a value of 1.00, the higher the degree of planar orientation of the cordierite crystallites.

Each value listed in Table 1 is a mean value determined from 5 or 6 individual measurements. The results are shown for samples taken from the top skin (“TS” in Table 1) and geometric center/mid-core regions (“MC” in Table 1) of the fired cordierite honeycombs. Differences (Delta(MC−TS)) between the values obtained at the top skin and mid-core regions for each property are also listed in Table 1. The results show that the least variability between the properties of the skin and core regions (Sample 3) is obtained when the honeycomb was heated from the first temperature to the second temperature at the lowest heating rate and the oxygen concentration was the highest, in which, produced.

TABLE 1

| | Sample 1 | Sample 2 | Sample 3 |
|---|---|---|---|
| Ave Heating Rate (° C./hr) | 3.86 | 3.51 | 3.31 |
| (1000-1160° C.) | | | |
| Ave % O2 (1000-1160° C.) | 9.3 | 9.5 | 11.4 |
| CTE TS (X10−7 cm/cm/° C.) | 3.6 | 4.1 | 3.8 |
| CTE MC (X10−7 cm/cm/° C.) | 5.8 | 5.3 | 4 |
| Delta (MC − TS) | 2.2 | 1.2 | 0.2 |
| MPS TS (μm) | 12.9 | 11.9 | 13.4 |
| MPS MC (μm) | 13.9 | 13.7 | 13.4 |
| Delta (MC − TS) | 1 | 1.8 | 0 |
| Tot. Int. Vol. TS (ml/g) | 0.401 | 0.39 | 0.407 |
| Tot. Int. Vol. MC (ml/g) | 0.409 | 0.446 | 0.421 |
| Delta (MC − TS) | 0.008 | 0.056 | 0.014 |
| MOR TS (psi) | 316 | 307 | 373 |
| MOR MC (psi) | 267 | 296 | 374 |
| Delta (MC − TS) | −49 | −11 | 1 |
| E-Mod TS (X10−6 psi) | 0.68 | 0.72 | 0.66 |
| E-Mod MC (X10−6 psi) | 0.6 | 0.67 | 0.65 |
| Delta (MC − TS) | −0.08 | −0.05 | −0.01 |
| Transverse I-ratio TS | 0.88 | — | 0.88 |
| Transverse I-ratio MC | 0.865 | — | 0.83 |
| Delta (MC − TS) | −0.015 | — | −0.05 |

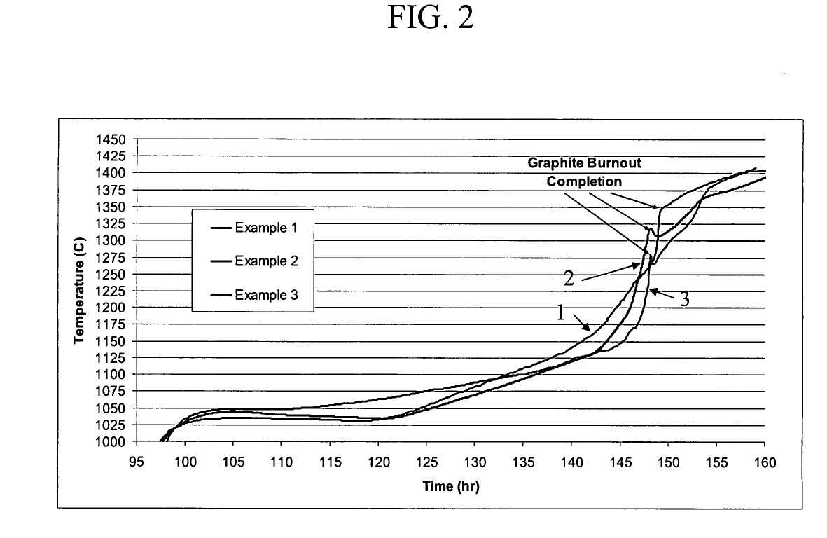

Thermocouple data for the mid-core or geometric center of the samples listed in Table 1 are plotted in FIG. 2. The point at which graphite removal or “burn-out” is complete is noted for each sample, and ranges from about 1350° C. for Sample 1 to about 1275° C. for Sample 3. The results shown in FIG. 2 and Table 1 show that the lower the temperature at which graphite is completely removed, the smaller the variation in different physical properties of the fired cordierite body. Accordingly, by reducing the temperature at which graphite is removed from the cordierite-forming body, the methods described herein provides cordierite bodies that have uniform properties throughout.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

1. A method of removing graphite from a cordierite-forming green body, the method comprising the steps of:
a. providing the cordierite-forming green body, the cordierite-forming green body having a core region and a skin region and comprising graphite;
b. heating the core region to a first temperature, the first temperature being in a range from about 950° C. up to about 1100° C.;
c. one of:
holding the core region at the first temperature for a first time interval; and
ii. heating the core region from the first temperature to a second temperature at a first predetermined heating rate, the second temperature being greater than the first temperature and in a range from about 1050° C. up to about 1160° C.; and
d. heating the core region from one of the first temperature and the second temperature to a third temperature, wherein the third temperature is in a range from about 1300° C. up to about 1350° C. at a second predetermined heating rate, wherein the third temperature is sufficient to remove graphite from the core region of the cordierite-forming green body.

2. The method according to claim 1, wherein the core region of the cordierite-forming green body is substantially free of graphite after being heated to the third temperature.

3. The method according to claim 1, wherein the first predetermined heating rate is less than or equal to about 1° C./hr.

4. The method according to claim 1, further including the step of holding the core region at the second predetermined temperature for a second predetermined time period.

5. The method according to claim 1, wherein each of the steps of holding the core region at the first temperature for the first time interval and heating the core region from the first temperature to a second temperature at a first predetermined heating rate further comprise heating the cordierite-forming green body in an atmosphere having an oxygen concentration ranging from about 9% up to about 13%.

6. The method according to claim 1, further including the step of firing the cordierite-forming green body at a fourth temperature of at least 1390° C. to form a fired cordierite body.

7. The method according to claim 6, wherein the core region of the fired cordierite body has at least one of a total intrusion, a mean pore size, a modulus of rupture, and an elastic modulus that is within 10% of that of the skin region.

8. The method according to claim 6, wherein the core region of the fired cordierite body has a percentage of crystal orientation that is within 3% of that of the skin region.

9. The method according to claim 1, wherein the step of providing a cordierite-forming green body comprises providing a cordierite-forming green body containing from about 1% up to about 60% graphite by weight.

10. The method according to claim 1, wherein the step of providing a cordierite-forming green body comprises providing an extruded cordierite-forming green body.

11. The method according to claim 1, wherein the cordierite-forming green body has a honeycomb structure.

12. The method according to claim 1, wherein:
a. step (c) comprises heating the cordierite-forming green body from the first temperature up to a second temperature of about 1160° C. at a first heating rate of up to about 4° C./hr; and
b. the step of heating the core region from one of the first temperature and the second temperature to a third temperature comprises heating the cordierite-forming green body from the second temperature to a third temperature in a range from about 1300° C. up to about 1350° C. at a second heating rate in a range from about 5° C./hr up to about 100° C./hr.

13. A method of firing a cordierite-forming green body to form a fired cordierite body, the method comprising the steps of:
a. providing the cordierite-forming green body, the ceramic body having a core region and a skin region;
b. heating the core region to a first temperature, the first temperature being in a range from about 950° C. up to about 1100° C.;
c. one of:
i. holding the core region at the first temperature for a first time interval; and
ii. heating the core region from the first temperature to a second temperature at a first predetermined heating rate, the second temperature being greater than the first temperature and in a range from about 1050° C. up to about 1160° C.;
d. heating the core region from one of the first temperature and the second temperature to a third temperature, wherein the third temperature is in a range from about 1300° C. up to about 1350° C. at a second predetermined heating rate, wherein the third temperature is sufficient to remove graphite from the core region of the cordierite-forming green body;
e. heating the core region from the third temperature to a fourth temperature, wherein the fourth temperature is at least 1390° C.; and
f. holding the core region at the fourth temperature for a time interval ranging from about 6 hours up to 20 hours to form the fired cordierite body.

14. The method according to claim 13, wherein the core region of the cordierite-forming green body is substantially free of graphite after being held at the first temperature for a first time interval or being heated to the second temperature.

15. The method according to claim 13, wherein the first predetermined heating rate is less than or equal to about 10° C./hr.

16. The method according to claim 13, further including the step of holding the core region at the second predetermined temperature for a second predetermined time period, the second predetermined time period being sufficient to remove graphite from the core region of the cordierite-forming green body.

17. The method according to claim 13, wherein each of the steps of holding the core region at the first temperature for the first time interval and heating the core region from the first temperature to a second temperature at a first predetermined heating rate further comprise heating the cordierite-forming green body in an atmosphere having an oxygen concentration ranging from about 9% up to about 13%.

18. The method according to claim 13, wherein the core region of the fired cordierite body has at least one of a total intrusion, a mean pore size, a modulus of rupture, and an elastic modulus that is within 10% of that of the skin region.

19. The method according to claim 13, wherein the core region of the fired cordierite body has a percentage of crystal orientation that is within 3% of that of the skin region.

20. The method according to claim 13, wherein the step of providing a cordierite-forming green body comprises providing a cordierite-forming green body containing from about 5% up to about 12% graphite by weight.

21. The method according to claim 13, wherein the step of providing a cordierite-forming green body comprises providing an extruded cordierite-forming green body.

22. The method according to claim 13, wherein the second predetermined heating rate is in a range from about 5° C./hr up to 100° C./hr.

23. The method according to claim 13, wherein:
a. step (c) comprises heating the cordierite-forming green body from the first temperature up to a second temperature of about 1160° C. at a first heating rate of up to about 4° C./hr; and
b. the step of heating the core region from one of the first temperature and the second temperature to a third temperature comprises heating the cordierite-forming green body from the second temperature to a third temperature in a range from about 1300° C. up to about 1350° C. at a second heating rate in a range from about 5° C./hr up to about 100° C./hr.

24. A cordierite body, the cordierite body having a skin region and a core region, the core region being substantially free of graphite, wherein the core region has a percentage of crystal orientation that is within 3% of that of the skin region.

25. The cordierite body according to claim 24, wherein the core region of the cordierite body has at least one of a total intrusion, a mean pore size, a modulus of rupture, and an elastic modulus that is within 10% of that of the skin region.
